(19) United States
(12) Patent Application Publication
(10) Pub. No.: US 2019/0152022 A1
(43) Pub. Date: May 23, 2019

(54) GRIPPING APPARATUS FOR GRIPPING A SHOE LAST

(71) Applicant: POU CHEN CORPORATION, Chang Hwan Hsien (TW)

(72) Inventors: Chien-Yu HSU, Chang Hwa Hsien (TW); Yu-Fong YANG, Chang Hwa Hsien (TW); Han-Cheng CHEN, Taichung City (TW)

(21) Appl. No.: 16/057,990

(22) Filed: Aug. 8, 2018

(30) Foreign Application Priority Data
Nov. 23, 2017 (TW) 106140668

(51) Int. Cl. B25B 5/04; B25B 5/06

(52) U.S. Cl. CPC B25B 5/04; B25B 5/061

(57) ABSTRACT

A gripping apparatus includes a frame unit, a gripping unit, a driving unit and a pushing unit. The gripping unit includes two gripping claws. The driving unit includes a central shaft unit and an actuating mechanism operable to move the central shaft unit such that the gripping claws are converted to grip a gripped portion of a shoe last or release the gripped portion. The pushing unit includes a driving mechanism and a pushing seat drivable by the driving mechanism to move to a lifted position to be in contact with the gripped portion. The frame unit includes two positioning members each having a positioning groove spatially communicated with a receiving space defined between the gripping claws and receiving a part of the gripped portion.

### CROSS-REFERENCE TO RELATED APPLICATION

This application claims priority of Taiwanese Invention Patent Application No. 106140668, filed on Nov. 23, 2017.

### FIELD

The disclosure relates to a gripping apparatus for gripping footwear, and more particularly to a gripping apparatus for gripping a shoe last.

### BACKGROUND

FIG. 1 illustrates a conventional gripping apparatus 1 disclosed in Chinese Utility Model Patent No. CN 203492906 U. The conventional gripping apparatus 1 includes a frame unit 11, two gripping claws 13 that are pivotally connected to the frame unit 11 by two pivot pins 14, and a driving unit 12 that is disposed between the gripping claws 13. The driving unit 12 includes a cylinder 121 that is connected to the frame unit 11, and a piston rod 122 that movably extends from the cylinder 121 along a height direction (H). Lower ends 131 of the gripping claws 13 are pivotally connected to a lower end of the piston rod 122 of the driving unit 12. The piston rod 122 is operable to move downwardly to rotate the gripping claws 13 to grip a shoe last 10, and is operable to move upwardly to rotate the gripping claws 13 to release the shoe last 10.

The conventional gripping apparatus 1 may be used in an automated shoe production line for different processing purposes, such as applying glue to a shoe vamp on the shoe last 10 or roughening the shoe vamp, etc. However, when multiple conventional gripping apparatuses 1 are used in the automated shoe production line, the conventional gripping apparatuses 1 may not be able to be precisely aligned in a horizontal direction, thereby causing the shoe lasts 10 to be horizontally misaligned from each other. This may result in manufacturing errors.

### SUMMARY

Therefore, an object of the disclosure is to provide a gripping apparatus that can alleviate the drawback of the prior art.

According to an aspect of the present disclosure, a gripping apparatus is adapted for gripping a gripped portion of a shoe last. The gripping apparatus includes a frame unit, a gripping unit, a driving unit and a pushing unit.

The gripping unit is mounted to the frame unit, and includes two gripping claws that are spaced apart from each other in a front-rear direction and that cooperatively define a receiving space therebetween. Each of the gripping claws has a main body that has a gripping portion located at an upper end thereof. The gripping portions of the gripping claws are adapted cooperatively to grip the gripped portion of the shoe last. The driving unit is mounted to the frame unit, and includes an actuating mechanism, and a central shaft unit that is connected between the actuating mechanism and the gripping claws. The actuating mechanism is operable to move the central shaft unit relative to the frame unit, such that the gripping claws are converted between a gripping state, where the gripping portions of the gripping claws grip the gripped portion of the shoe last, and a releasing state, where the gripping portions of the gripping claws release the gripped portion of the shoe last. The pushing unit includes a driving mechanism that is mounted to the frame unit, and a pushing seat that is connected to the driving mechanism and that is located between the gripping claws. The driving mechanism is operable to drive the pushing seat to move in an upper-lower direction between a lowered position, where the pushing seat is spaced apart from the gripped portion of the shoe last, and a lifted position, where the pushing seat is in contact with the gripped portion of the shoe last. The frame unit includes two positioning members adjacent to the gripping portions of the main bodies of the gripping claws. Each of the positioning members has a positioning groove that is spatially communicated with the receiving space, and that is adapted for receiving a part of the gripped portion of the shoe last.

### BRIEF DESCRIPTION OF THE DRAWINGS

Other features and advantages of the disclosure will become apparent in the following detailed description of the embodiment and variation with reference to the accompanying drawings, of which:

FIG. 1 is a schematic side view of a conventional gripping apparatus of Chinese Utility Model Patent No. CN 203492906 U;

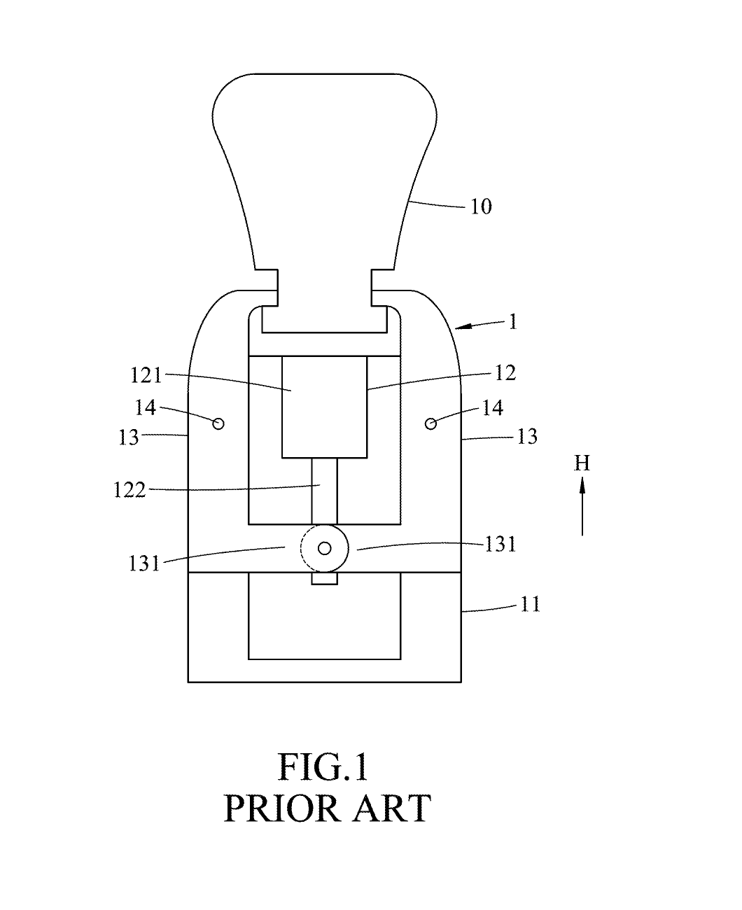

FIG. 2 is a schematic perspective view of an embodiment of a gripping apparatus according to the present disclosure, which grips a gripped portion of a shoe last;

FIG. 3 is a partially exploded perspective view of the embodiment;

FIG. 4 is a fragmentary perspective view of the embodiment;

FIG. 5 is another fragmentary perspective view of the embodiment;

FIG. 6 is a partially exploded view of FIG. 4;

FIG. 7 is a schematic side view of the embodiment, showing two gripping claws of a gripping unit of the embodiment being in a gripping state and gripping the gripped portion of the shoe last;

FIG. 8 is a schematic side view of the embodiment, showing the gripping claws being in a releasing state and releasing the gripped portion of the shoe last;

FIG. 9 is a sectional view of the embodiment taken along line IX-IX of FIG. 2, wherein a pushing seat of a pushing unit of the embodiment is at a lowered position; and

FIG. 10 is a sectional view similar to FIG. 9, but shows the pushing seat at a lifted position.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

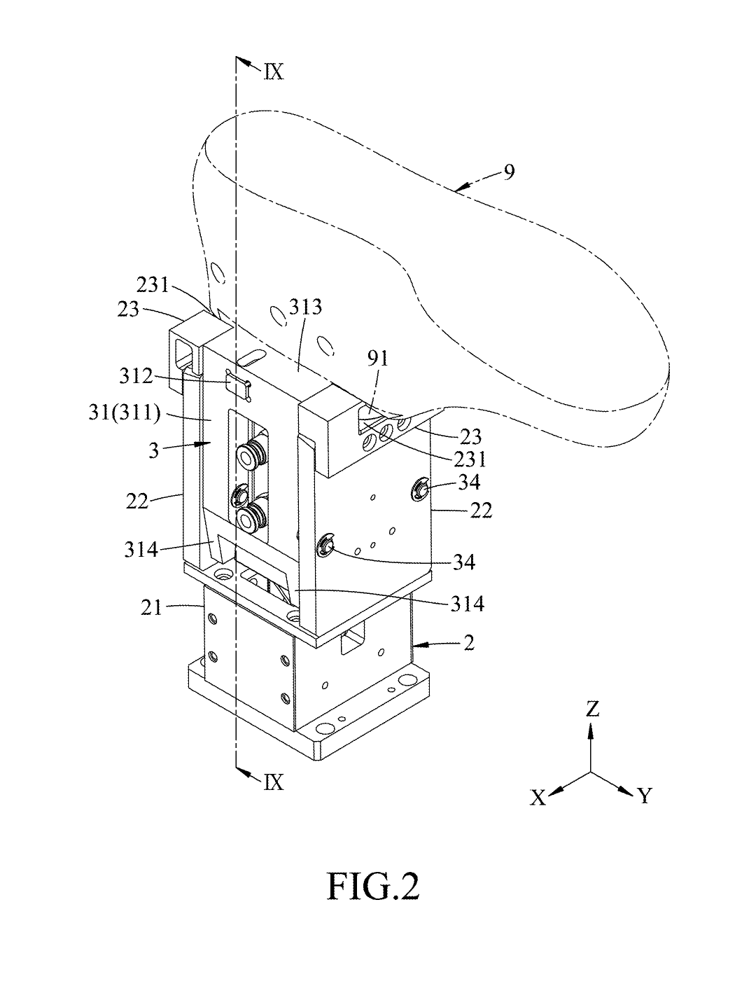

Referring to FIGS. 2 to 4, an embodiment of a gripping apparatus of this disclosure is adapted for gripping a gripped portion 91 of a shoe last 9. The gripped portion 91 of the shoe last 9 has two opposite sides that are respectively formed with two aligned positioning grooves 911. The gripping apparatus includes a frame unit 2, a gripping unit 3, a driving unit 32, a pushing unit 4 and two guiding units 5.

The frame unit 2 includes a base seat 21, two mounting walls 22 that are spaced apart from each other in a left-right direction (Y) and that extends upwardly from the base sear 21, and two positioning members 23 that are respectively mounted to upper ends of the mounting walls 22. Each of the mounting walls 22 has a mounting groove 221 that extends in an upper-lower direction (Z) and that has an opening. The openings of the mounting grooves 221 of the mounting walls 22 are aligned with each other along the left-right direction (Y). Each of the positioning members 23 has a positioning groove 231 that is formed therethrough in the left-right direction (Y).

The gripping unit 3 is mounted to the frame unit 2, and includes two gripping claws 31 that are spaced apart from each other in a front-rear direction (X) and that are respectively and pivotally connected to the mounting walls 22, and two fixed shaft units 34. The gripping claws 31 cooperatively define a receiving space 300 therebetween. The positioning groove 231 of each of the positioning members 23 is spatially communicated with the receiving space 300, and is adapted for receiving a part of the gripped portion 91 of the shoe last 9. Each of the gripping claws 31 has a main body 311 that is located between the mounting walls 22, that has a gripping portion 313 located at an upper end thereof and two pivot connecting portions 314 located at lower end thereof. The gripping portions 313 of the gripping claws 31 are adapted cooperatively to grip the gripped portion 91 of the shoe last 9. Each of the gripping claws 31 further has a positioning protrusion 312 that extends in the front-rear direction (X) from the gripping portion 313 of the main body 311. The fixed shaft units 34 extend through the mounting walls 22 of the frame unit 2 and respectively extend through the main bodies 311 of the gripping claws 31 such that each of the gripping claws 31 is pivotally connected between the mounting walls 22. In this embodiment, each of the fixed shaft units 34 includes two fixed shafts 341 that respectively extend through the mounting walls 22 and that extend into a respective one of the main bodies 311 of the gripping claws 31. It is worth mentioning that the front-rear direction (X) and the left-right direction (Y) may be interchanged based on practical requirements, such as configuration of the production line.

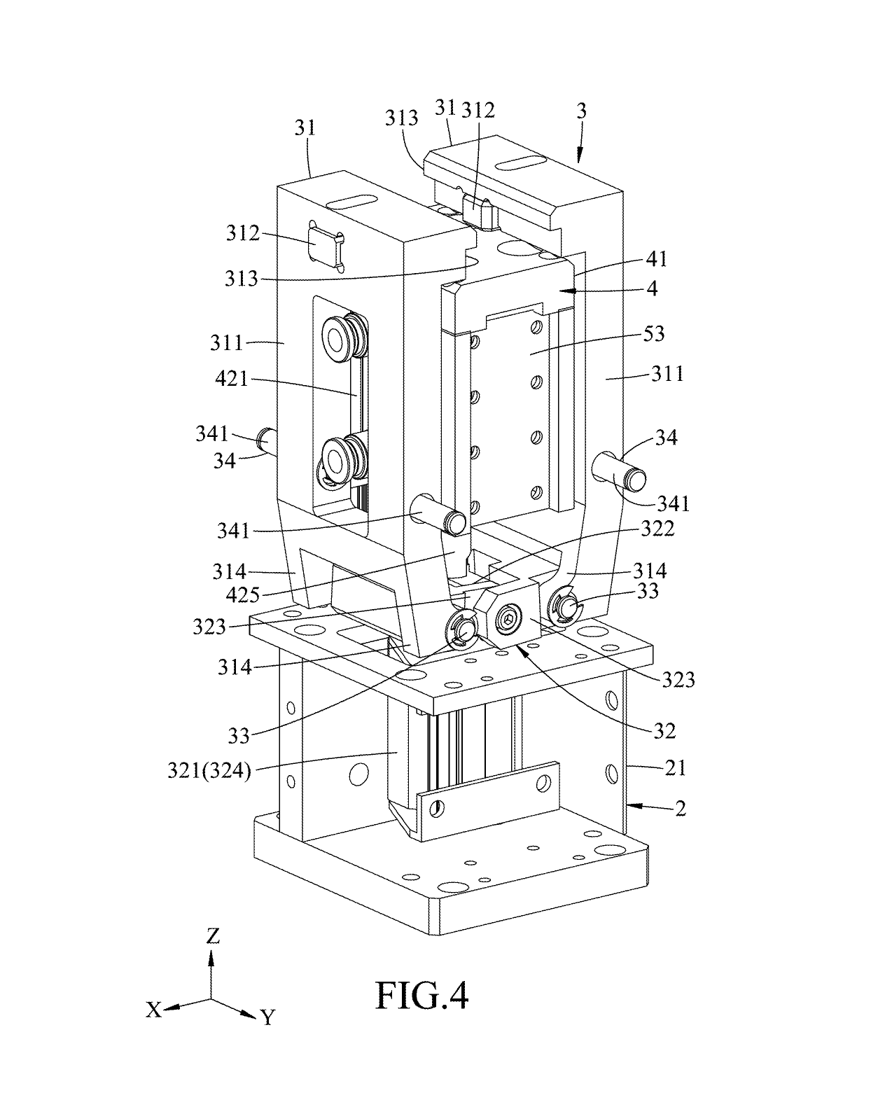

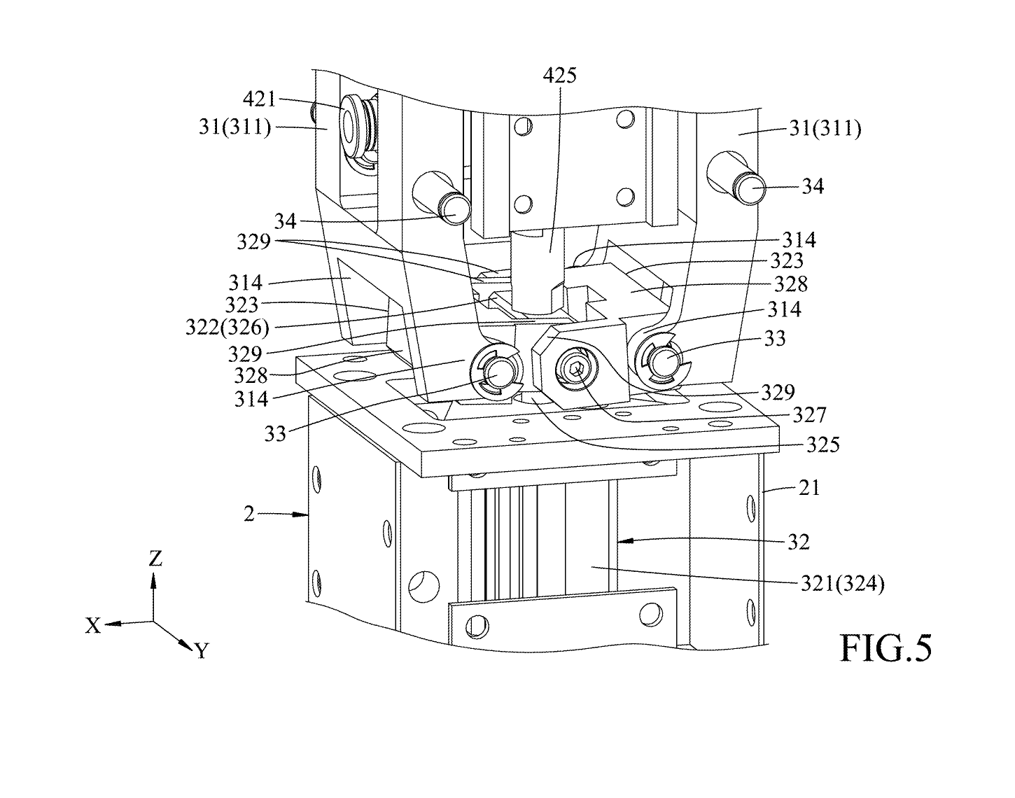

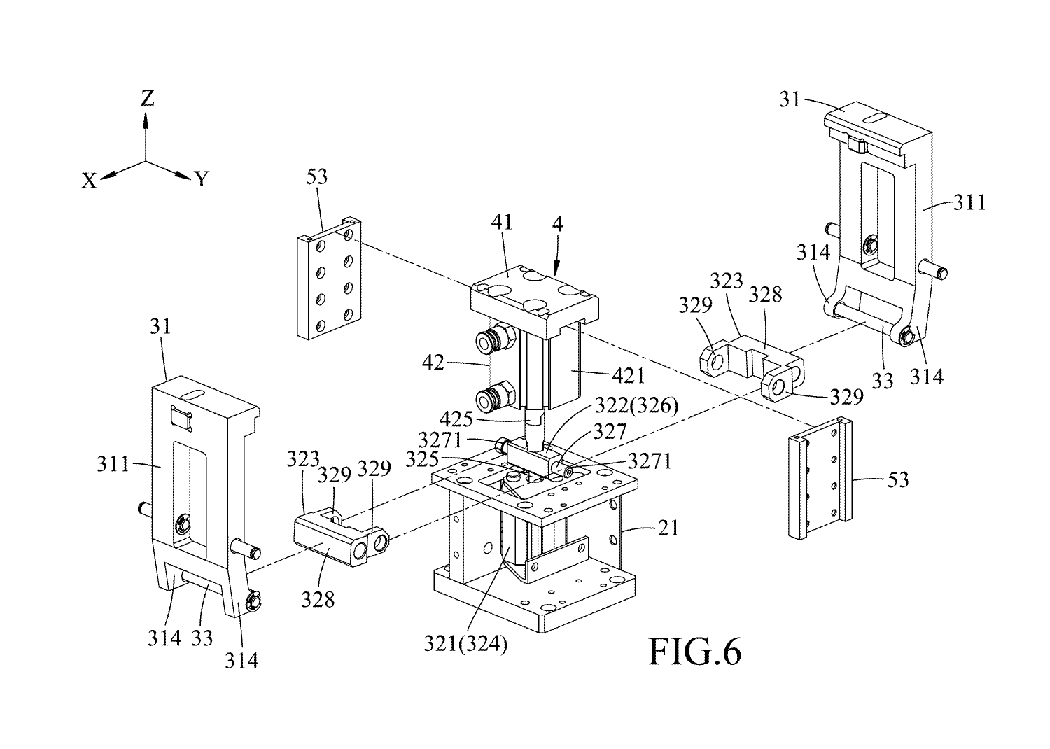

Referring to FIGS. 4 to 6, the driving unit 32 is mounted to the frame unit 2, and includes an actuating mechanism 321 that is mounted to the base seat 21 of the frame unit 2, a central shaft unit 322 that is connected between the actuating mechanism 321 and the gripping claws 31, two link members 323 that are pivotally connected to the central shaft unit 322, and two connecting shafts 33. In this embodiment, the actuating mechanism 321 is configured to be a pneumatic cylinder, and includes a cylinder 324 that is fixedly mounted to the base seat 21 of the frame unit 2, and a piston rod 325 that movably and upwardly extends from the cylinder 324 in the upper-lower direction (Z), and that is connected to the central shaft unit 322. The central shaft unit 322 includes a central seat 326 that is fixedly connected to a top end of the piston rod 325 of the actuating mechanism 321, and a fixing shaft 327 that extends through the central seat 326 in the left-right direction (Y) and that has two opposite distal ends 3271 exposed from the central seat 326. Each of the connecting shafts 33 extends through the pivot connecting portions 314 of a respective one of the gripping claws 31 and a respective one of the link members 323 such that the gripping claws 31 are pivotally connected to the link members 323. Specifically, each of the link members 323 has a pivot connecting portion 328 that is pivotally connected between the pivot connecting portions 314 of the respective one of the gripping claws 31 by the respective one of the connecting shafts 33, and two lugs 329 that respectively extend from opposite ends of the pivot connecting portion 328 and that are respectively and rotatably sleeved on the distal ends 3271 of the fixing shaft 327. The lugs 329 of one of the link members 323 are located between the lugs 329 of the other one of the link members 323. The central seat 326 of the central shaft unit 322 is located between the lugs 329 of the one of the link members 323. It is worth mentioning that, in practical application, the link members 323 may be omitted and the pivot connecting portions 314 of the gripping claws 31 may be directly connected with the central shaft unit 322 as long as the gripping claws 31 are pivotable relative to the central shaft unit 322.

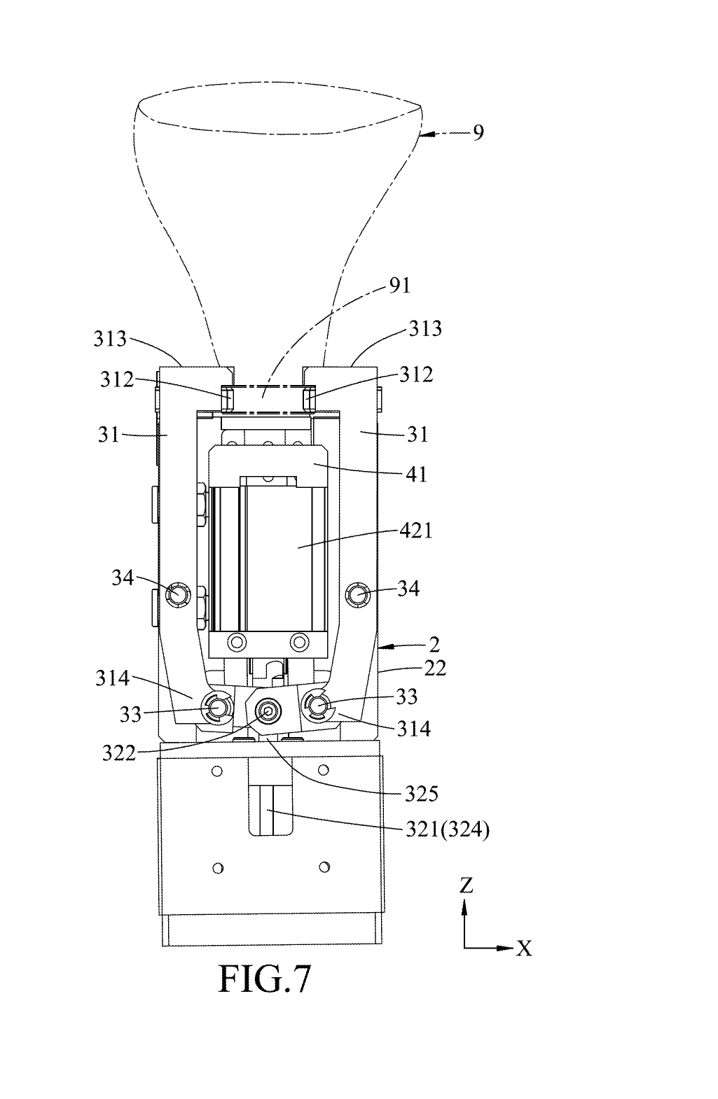

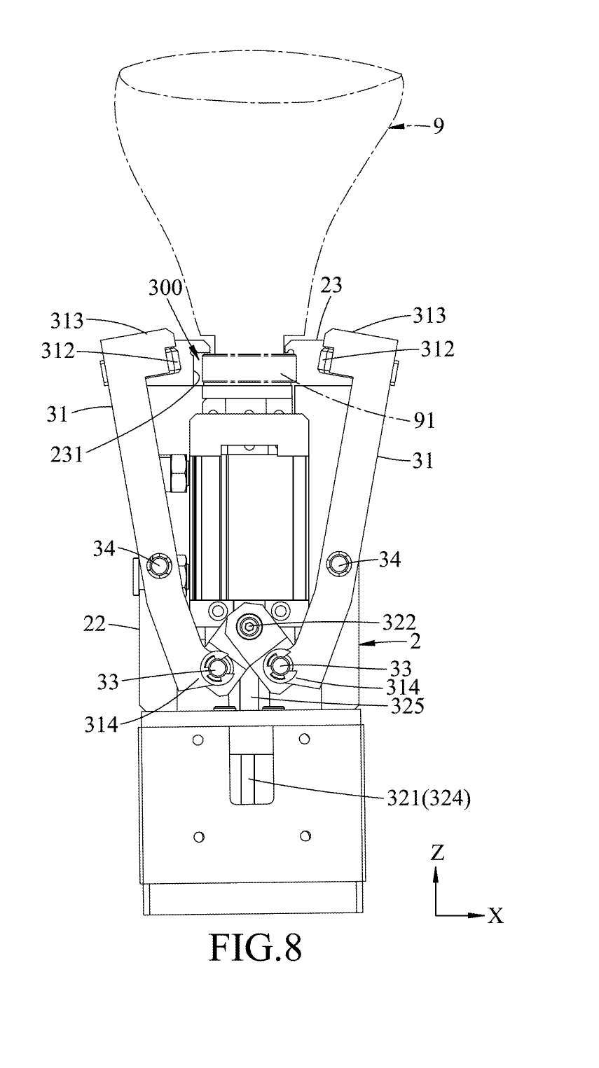

Referring to FIGS. 2, 5, 7 and 8, the actuating mechanism 321 is operable to move the central shaft unit 322 relative to the mounting walls 22 of the frame unit 2, such that the gripping claws 31 are converted between a gripping state (see FIG. 7), where the gripping portions 313 of the gripping claws 31 grip the gripped portion 91 of the shoe last 9, and a releasing state (see FIG. 8), where the gripping portions 313 of the gripping claws 31 release the gripped portion 91 of the shoe last 9.

Specifically, when converting the gripping claws 31 from the releasing state to the gripping state, the piston rod 325 of the actuating mechanism 321 is operated to retract into the cylinder 324 such that the central shaft unit 322 and the lugs 329 of each of the link members 323 are moved downwardly and the pivot connecting portion 328 of each of the link members 323 is moved upwardly. During such conversion, the pivot connecting portions 314 of one of the gripping claws 31 are moved away from the pivot connecting portions 314 of the other one of the gripping claws 31, such that the gripping claws 31 respectively pivot about the fixed shaft units 34, the gripping portions 313 of the gripping claws 31 are moved toward each other to grip the gripped portion 91 of the shoe last 9, and the positioning protrusions 312 of the gripping claws 31 are respectively moved to engage into the positioning grooves 911 of the gripped portion 91 of the shoe last 9. The engagement between the positioning protrusions 312 of the gripping claws 31 and the positioning grooves 911 of the gripped portion 91 of the shoe last 9 ensures that the shoe last 9 is firmly gripped by the gripping claws 31 when the gripping claws 31 are in the gripping state.

When converting the gripping claws 31 from the gripping state to the releasing state, the piston rod 325 of the actuating mechanism 321 is operated to extend out of the cylinder 324 such that the central shaft unit 322 and the lugs 329 of each of the link members 323 are moved upwardly and the pivot connecting portion 328 of each of the link members 323 is moved downwardly. During such conversion, the pivot connecting portions 314 of one of the gripping claws 31 are moved toward the pivot connecting portions 314 of the other one of the gripping claws 31, such that the gripping claws 31 respectively pivot about the fixed shaft units 34, the gripping portions 313 of the gripping claws 31 are moved away from each other to release the gripped portion 91 of the shoe last 9, and the positioning protrusions 312 of the gripping claws 31 respectively disengage from the positioning grooves 911 of the gripped portion 91 of the shoe last 9.

When the gripping claws 31 are in the gripping state, a central axis of each of the connecting shafts 33 is not lower than a central axis of the central shaft unit 322 in the upper-lower direction (Z). When the gripping claws 31 are in the releasing state, the central axis of each of the connecting shafts 33 is lower than the central axis of the central shaft unit 322 in the upper-lower direction (Z).

Alternatively, the gripping claws 31 may be configured to move horizontally in the front-rear direction (X) relative to each other, as long as the gripping claws 31 are operable to grip or release the gripped portion 91 of the shoe last 9.

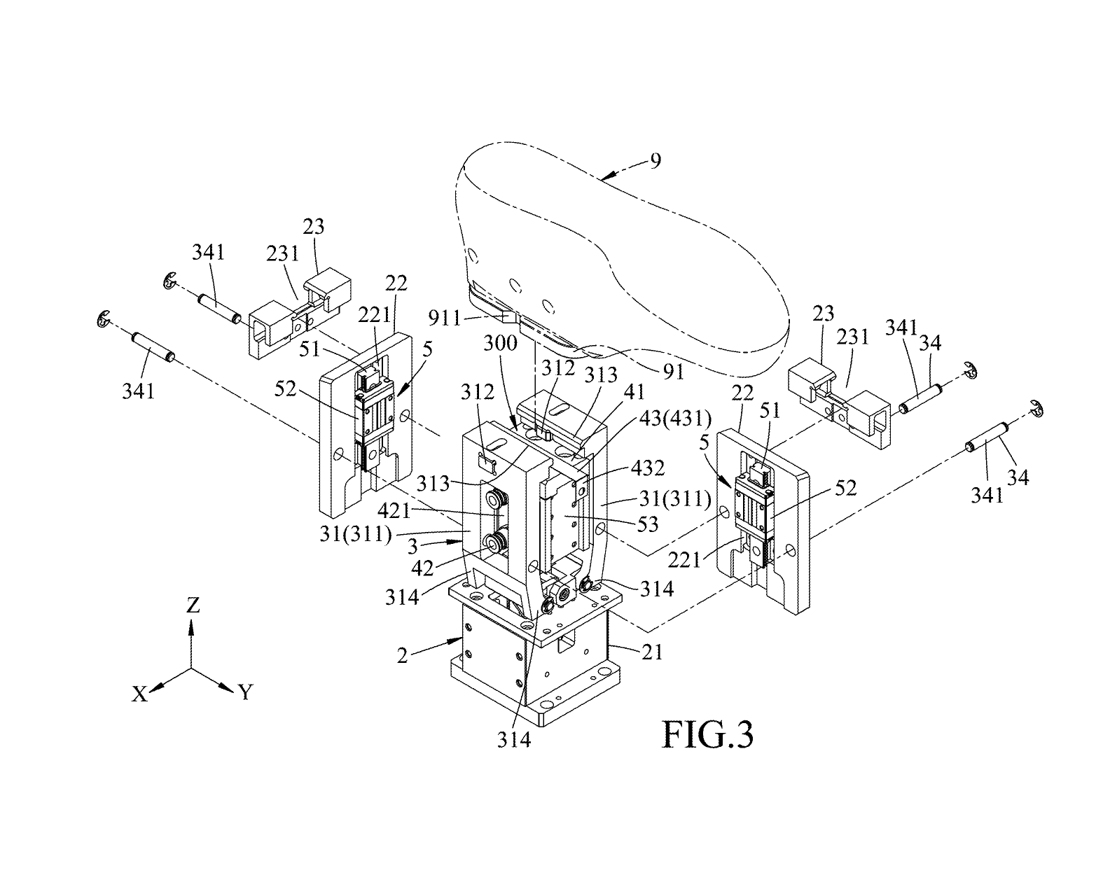

Referring to FIGS. 3, 4 and 6, the pushing unit 4 includes a driving mechanism 42 that is mounted to the base seat 21 of the frame unit 2, a pushing seat 41 that is connected to the driving mechanism 42 and that is located between the gripping claws 31, a slide-assisting member 43 that is disposed on the pushing seat 41 and that is connected between the pushing seat 41 and the positioning members 23 and is movable in the upper-lower direction (Z). The pushing seat 41 is located below the gripping portions 313 of the gripping claws 31. In this embodiment, the driving mechanism 42 is configured to be a pneumatic cylinder, and includes a driving cylinder 421 that is connected to a bottom end of the pushing seat 41, and a piston rod 425 that movably and downwardly extends from the driving cylinder 421 and that is fixedly connected to the central seat 326 of the central shaft unit 322. In this embodiment, the piston rod 325 of the actuating mechanism 321 of the driving unit 32 and the piston rod 425 of the driving mechanism 42 of the pushing unit 4 are coaxial in the upper-lower direction (Z) and are respectively located at opposite sides of the central seat 326 of the central shaft unit 322. Such coaxial configuration minimizes component forces that are not in the upper-lower direction (Z) and ensures stable operation of the driving unit 32 and the pushing unit 4. The slide-assisting member 43 is inverted U-shaped, and has a main body 431 that is disposed on and above the pushing seat 41 and two side portions 432 that respectively extend from two opposite ends of the main body 431. Each of the side portions 432 is disposed between the pushing seat 41 and a respective one of the positioning members 23. In this embodiment, each of the side portions 432 of the slide-assisting member 43 is loosely connected to the respective one of the positioning members 23 through a screw to be movable in the upper-lower direction (Z), allowing the pushing seat 41 to move upwardly without being significantly limited by the slide-assisting member 43. The slide-assisting member 43 facilitates the gripped portion 91 of the shoe last 9 to smoothly slide into the receiving space 300.

The guiding units 5 are connected to the frame unit 2 and the pushing seat 41 for guiding the pushing seat 41 to move in the upper-lower direction (Z). Specifically, each of the guiding units 5 is connected between the pushing seat 41 and a respective one of the mounting walls 22 of the frame unit 2. Each of the guiding units 5 includes a slide rail 51 that is disposed in the mounting groove 221 of the respective one of the mounting walls 22 and that extends along the upper-lower direction (Z), a slide block 52 that is slidably mounted to the slide rail 51, and a connecting plate 53 that is fixedly connected between the bottom end of the pushing seat 41 and the slide block 52, so that the slide block 52 is fixedly connected to the pushing seat 41 for guiding the pushing seat 41 to move in the upper-lower direction (Z). The guiding units 5 ensure that the driving cylinder 421 smoothly moves in the upper-lower direction (Z).

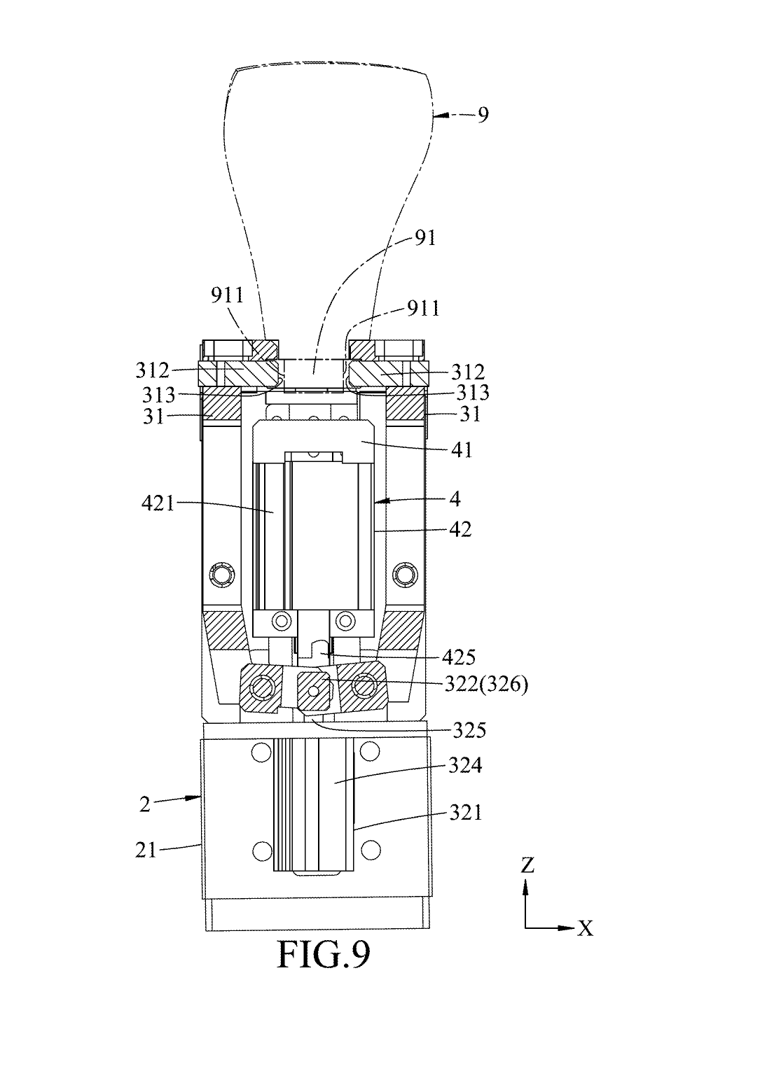

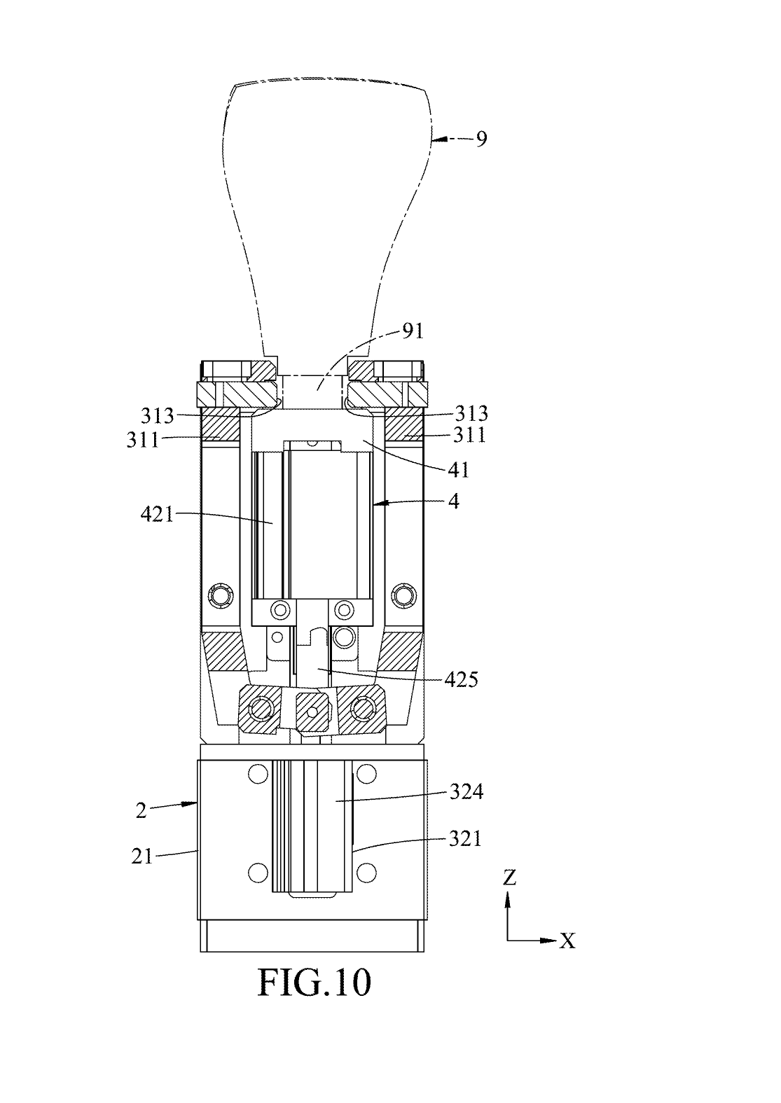

Referring to FIGS. 4, 6, 9 and 10, the driving mechanism 42 is operable to drive the pushing seat 41 to move in the upper-lower direction (Z) between a lowered position (see FIG. 9), where the pushing seat 41 is spaced apart from the gripped portion 91 of the shoe last 9 and is close to the central shaft unit 322, and a lifted position (see FIG. 10), where the pushing seat 41 is in contact with the gripped portion 91 of the shoe last 9 and is away from the central shaft unit 322.

It is worth mentioning that the driving force moving the pushing seat 41 is greater than the gripping force of the gripping claws 31, allowing the pushing seat 41 to be movable in the upper-lower direction (Z) between the lifted position and the lowered position when the gripping claws 31 are in the gripping state.

Referring to FIG. 8, in operation, a shoe vamp (not shown) to be processed is first sleeved on the shoe last 9, followed by operating the piston rod 325 to extend further out of the cylinder 324 to drive the gripping claws 31 to convert into the releasing state. Afterwards, the gripped portion 91 of the shoe last 9 is placed in the receiving space 300. The slide-assisting member 43 (see FIG. 3) facilitates the gripped portion 91 of the shoe last 9 to slide to a desired position in the receiving space 300 and prevents the gripped portion 91 of the shoe last 9 from being stuck by the gaps between the positioning members 23 and the pushing seat 41. Since the slide-assisting member 43 is in slidable contact with the positioning members 23, it does not hinder upward movement of the pushing seat 41 in the upper-lower direction (Z). Then, referring to FIG. 7, the piston rod 325 is operated to retract into the cylinder 324 (i.e., move downwardly relative to the cylinder 324) to drive the gripping claws 31 to convert into the gripping state, such that the positioning protrusions 312 of the gripping claws 31 are respectively engaged into the positioning grooves 911 of the gripped portion 91 of the shoe last 9. Next, as shown in FIG. 10, the piston rod 425 of the driving mechanism 42 is operated to move downwardly relative to the driving cylinder 421 to drive the pushing seat 41 to move to the lifted position and to be in contact with the gripped portion 91 of the shoe last 9, thereby ensuring that the shoe last 9 to be placed at a desirable altitude in the upper-lower direction (Z). Finally, the gripping apparatus conveys the shoe last 9 and the shoe vamp to different workstations for different processes, such as roughening, adhesive applying, etc.

The advantages of the gripping apparatus according to the present disclosure are summarized as follows.

When the pushing seat 41 is at the lifted position, the pushing seat 41 is in contact with the gripped portion 91 of the shoe last 9 to ensure that each shoe last 9 conveyed by the gripping apparatus is located at the same altitude in the upper-lower direction (Z), allowing the shoe vamp on each shoe last 9 to be precisely processed.

The engagement between the positioning protrusions 312 of the gripping claws 31 and the positioning grooves 911 of the gripped portion 91 of the shoe last 9 ensures that the shoe last 9 is firmly gripped by the gripping claws 31 when the gripping claws 31 are in the gripping state and ensures that each shoe last 9 is located at the same position in the left-right direction (Y). Such configuration also allows the shoe vamp on each shoe last 9 to be precisely processed.

The positioning grooves 231 of the positioning members 23 provide extra space for receiving the gripped portion 91 of the shoe last 9, thereby improving stability of the shoe last 9 when gripped by the gripping claws 31.

The coaxial configuration of the piston rod 325 of the actuating mechanism 321 of the driving unit 32 and the piston rod 425 of the driving mechanism 42 of the pushing unit 4 minimizes component forces that are not in the upper-lower direction (Z) and ensures stable operation of the driving unit 32 and the pushing unit 4.

The guiding units 5 facilitate smooth movement of the pushing seat 41 in the upper-lower direction (Z), and also prolong service life of the driving mechanism 42.

In the description above, for the purposes of explanation, numerous specific details have been set forth in order to provide a thorough understanding of the embodiment and variation. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiment and variation, it is understood that this disclosure is not limited to the disclosed embodiment and variation but is intended to cover various arrangements included within the spirit and scope of the broadest interpretation so as to encompass all such modifications and equivalent arrangements.

What is claimed is:

1. A gripping apparatus adapted for gripping a gripped portion of a shoe last, said gripping apparatus comprising:
a frame unit;
a gripping unit mounted to said frame unit, and including two gripping claws that are spaced apart from each other in a front-rear direction and that cooperatively define a receiving space therebetween, each of said gripping claws having a main body that has a gripping portion located at an upper end thereof, said gripping portions of said gripping claws being adapted cooperatively to grip the gripped portion of the shoe last;
a driving unit mounted to said frame unit, and including an actuating mechanism and a central shaft unit that is connected between said actuating mechanism and said gripping claws, said actuating mechanism being operable to move said central shaft unit relative to said frame unit, such that said gripping claws (31) are converted between a gripping state, where said gripping portions of said gripping claws grip the gripped portion of the shoe last, and a releasing state, where said gripping portions of said gripping claws release the gripped portion of the shoe last; and
a pushing unit including a driving mechanism that is mounted to said frame unit and a pushing seat that is connected to said driving mechanism and that is located between said gripping claws, said driving mechanism being operable to drive said pushing seat to move in an upper-lower direction between a lowered position, where said pushing seat is spaced apart from the gripped portion of the shoe last, and a lifted position, where said pushing seat is in contact with the gripped portion of the shoe last,
wherein said frame unit includes two positioning members adjacent to said gripping portions of said main bodies of said gripping claws, each of said positioning members having a positioning groove that is spatially communicated with said receiving space and that is adapted for receiving a part of the gripped portion of the shoe last.

2. The gripping apparatus as claimed in claim 1, wherein:
said actuating mechanism includes a cylinder and a piston rod that movably extends from said cylinder of said actuating mechanism and that is connected to said central shaft unit;
said main body of each of said gripping claws further has two pivot connecting portions located at lower end thereof;
said driving unit further includes two link members that are pivotally connected to said central shaft unit, and two connecting shafts, each of said connecting shafts extending through said pivot connecting portions of a respective one of said gripping claws and a respective one of said link members such that said gripping claws are pivotally connected to said link members;
when said gripping claws are in the gripping state, a central axis of each of said connecting shafts is not lower than a central axis of said central shaft unit in the upper-lower direction; and
when said gripping claws are in the releasing state, the central axis of each of said connecting shafts is lower than the central axis of said central shaft unit in the upper-lower direction.

3. The gripping apparatus as claimed in claim 2, wherein:
said central shaft unit includes a central seat that is fixedly connected to a top end of said piston rod of said actuating mechanism and a fixing shaft that extends through said central seat and that has two opposite distal ends exposed from said central seat; and
each of said link members has a pivot connecting portion that is pivotally connected between said pivot connecting portions of the respective one of said gripping claws by the respective one of said connecting shafts, and two lugs that respectively extend from opposite ends of said pivot connecting portion and that are respectively and rotatably sleeved on said distal ends of said fixing shaft.

4. The gripping apparatus as claimed in claim 3, wherein said driving mechanism includes a driving cylinder that is connected to a bottom end of said pushing seat, and a piston rod that movably extends from said driving cylinder and that is fixedly connected to said central seat of said central shaft unit.

5. The gripping apparatus as claimed in claim 4, wherein:
said gripping apparatus further comprises two spaced apart guiding units that are connected to said frame unit and said pushing seat for guiding said pushing seat to move in the upper-lower direction; and
said piston rod of said actuating mechanism of said driving unit and said piston rod of said driving mechanism of said pushing unit are coaxial and are respectively located at opposite sides of said central seat of said central shaft unit.

6. The gripping apparatus as claimed in claim 5, wherein:
said frame unit further includes a base seat to which said cylinder of said actuating mechanism is fixedly connected, and two spaced apart mounting walls that extends upwardly from said base seat;
said positioning members of said frame unit are respectively mounted to upper ends of said mounting walls;
said gripping unit further includes two fixed shaft units that extend through said mounting walls of said frame unit and respectively extend through said main bodies of said gripping claws such that each of said gripping claws is pivotally connected between said mounting walls; and
each of said guiding units is connected between said pushing unit and a respective one of said mounting walls, and includes a slide rail that is connected to the respective one of said mounting walls and that extends along the upper-lower direction, and a slide block that is slidably mounted to said slide rail and fixedly connected to said pushing seat for guiding said pushing seat to move in the upper-lower direction.

7. The gripping apparatus as claimed in claim 6, wherein:
said pushing unit further includes a slide-assisting member that is disposed on said pushing seat and that is connected movably between said pushing seat and said positioning members; and
each of said guiding units includes a connecting plate that is fixedly connected between said bottom end of said pushing seat and said slide block.

8. The gripping apparatus as claimed in claim 7, wherein said slide-assisting member is inverted U-shaped and has a main body that is disposed on and above said pushing seat, and two side portions that respectively extend from two opposite ends of said main body of said slide-assisting member, each of said side portions being disposed between said pushing seat and a respective one of said positioning members.

9. The gripping apparatus as claimed in claim 1, wherein when said gripping claws are in the gripping state, said pushing seat is movable between the lifted position and the lowered position.

10. The gripping apparatus as claimed in claim 1, the gripped portion of a shoe last having two opposite sides that are respectively formed with two aligned positioning grooves, wherein:
each of said gripping claws further has a positioning protrusion that extends from said gripping portion of said main body; and
when said gripping claws are in the gripping state, said positioning protrusions of said gripping claws are respectively adapted to be engaged into the positioning grooves of the gripped portion of the shoe last.
